(19) United States
(12) Patent Application Publication
(10) Pub. No.: US 2011/0072440 A1
(43) Pub. Date: Mar. 24, 2011

(54) PARALLEL PROCESSING SYSTEM AND METHOD

(75) Inventors: Jung Hee LEE, Daejeon (KR); Sang Yoon OH, Daejeon (KR); Dong Myoung BAEK, Daejeon (KR); Bhum Cheol LEE, Daejeon (KR)

(73) Assignee: Electronics and Telecommunications Research Institute, Daejeon (KR)

(21) Appl. No.: 12/821,127

(22) Filed: Jun. 22, 2010

(30) Foreign Application Priority Data
Sep. 22, 2009 (KR) 10-2009-0089711

(51) Int. Cl. G06F 9/46

(52) U.S. Cl. 718/105

(57) ABSTRACT

A parallel processing system determines whether to drive all or some processors so as to process data that are input based on capacity or time for processing the input data. Also, the system temporarily stores the data that are processed and output by the respective processors, and controls the same to be output when it becomes the calculated output time based on the traffic processing time for the input data.

### CROSS-REFERENCE TO RELATED APPLICATION

This application claims priority to and the benefit of Korean Patent Application No. 10-2009-0089711 filed in the Korean Intellectual Property Office on Sep. 22, 2009, the entire contents of which are incorporated herein by reference.

### BACKGROUND OF THE INVENTION

(a) Field of the Invention

The present invention relates to a parallel processing system and method thereof.

(b) Description of the Related Art

In order to support 3-dimension (3D) simulation, media file streaming, improved security level, premium user interface, and improved database processing, high processor performance is required, but a single processor cannot fully support the functions. Multiple processors have been proposed to solve the problem.

However, in the case of following Amdahl's rule for showing a connection between the number of processors and program performance, the performance is no longer increased when the number of processors is greater than four. Therefore, performance of parallel processing cannot be improved by simply increasing the number of processors.

In general, a data center includes a plurality of servers and storage units in parallel and manages them by distributing a load, but such management is inefficient compared to actual performance of the servers and storage units and thereby requires power saving.

To overcome the limit of performance improvement through parallel processing, data packets are divided by flows, and the flows are allocated to the processors for parallel processing to guarantee the order of the flows and performance of the respective processors in the prior art. The above-suggested method has overcome the limit of performance caused by Amdahl's rule, but it distributes traffic and causes inefficiency when there are too many or few flows and the entire traffic is less. Also, the method increases power consumption and has a problem in which performance is not linearly increased for the number of processors used for parallel processing.

Accordingly, in order to solve the problem of power consumption and provide high-performance parallel processing, a method for selecting an optimized server by determining the work amounts of respective servers for performing parallel processing and topology, and controlling the selected server to process an application, has been proposed. However, the method must simultaneously know the work amounts of respective servers and topology and control a center station to control multiple processors or the servers operating individually. Also, it is more difficult to realize the method as the number of servers or processors for performing parallel processing is increased, and it is required to newly calculate the work amount and the topology as the number of servers or processors is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a parallel processing method having advantages of guaranteeing high performance, allowing less power consumption, and being independent of the number of processors or servers.

An exemplary embodiment of the present invention provides a parallel processing system including: a plurality of processors for processing data; a traffic processing performance calculator for calculating traffic processing performance based on attribute information of input data, and determining an output time corresponding the data based on the traffic processing performance; a load processing determiner for driving at least one of the processors according to a load distribution state that is determined based on the traffic processing performance, and controlling the at least one processor to process the data; and a standby buffer for storing processed data output by the at least one processor, and outputting the processed data based on the output time.

Another embodiment of the present invention provides a parallel processing method in a parallel processing system including a plurality of processors, including: calculating traffic processing capacity and traffic processing time based on attribute information of input data; determining an output time corresponding to the data based on the traffic processing time; determining whether to distribute a load based on the traffic processing capacity or the traffic processing time; driving at least one of the plurality of processors based on the load distribution state; storing processed data output by processing the data by the at least one processor; and outputting the processing data based on the output time.

### BRIEF DESCRIPTION OF THE DRAWINGS

FIG. 1 shows a configuration diagram of a parallel processing system according to an exemplary embodiment of the present invention.

FIG. 2 shows a flowchart of a parallel processing method by a parallel processing system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A parallel processing system and method according to an exemplary embodiment of the present invention will now be described with reference to accompanying drawings.

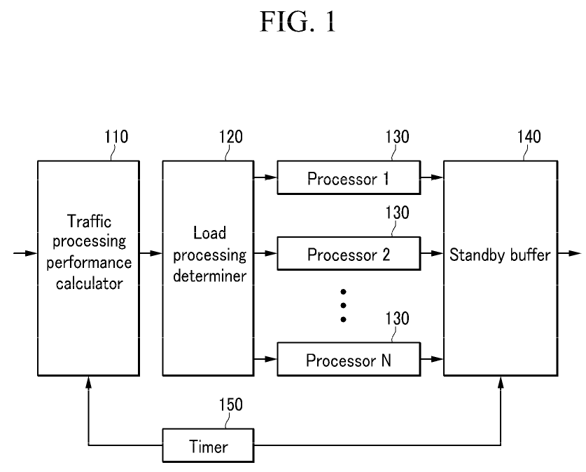

FIG. 1 shows a configuration diagram of a parallel processing system according to an exemplary embodiment of the present invention.

Referring to FIG. 1, the parallel processing system includes a traffic processing performance calculator 110, a load processing determiner 120, a plurality of processors 1 to N 130, a standby buffer 140, and a timer 150.

The traffic processing performance calculator 110 calculates traffic capacity and traffic processing time based on attribute information including input data size. Here, traffic processing capacity can be calculated in various ways according to attribute information of the input data, and traffic processing time is calculated based on processing performance and traffic processing capacity of a plurality of processors 130.

The traffic processing performance calculator 110 calculates processing finish time of the input data based on the traffic processing time, and determines output time of the processed data. Here, output time of the processed data can be calculated by adding traffic processing time of the currently input data to the output time corresponding to the previously input data.

The load processing determiner 120 determines whether to distribute the load based on the traffic processing capacity or traffic processing time calculated by the traffic processing performance calculator 110. That is, the load processing determiner 120 compares one of the traffic processing capacity and traffic processing time with a threshold value and determines whether to distribute the load applied to the data input to a plurality of processors 130 for performing parallel processing or concentrate the load to part of the plurality of processors 130.

Here, the load processing determiner 120 knows processing capacity of the processors 130, and compares the traffic processing capacity or traffic processing time calculated by the traffic processing performance calculator 110 with the threshold value calculated based on the processing capacity of the processors 130 to determine whether to distribute the load. That is, when the traffic processing capacity or traffic processing time exceeds the threshold value, the load processing determiner 120 determines to distribute the load, and when the traffic processing capacity or traffic processing time is less than the threshold value, the load processing determiner 120 determines to concentrate the load.

Also, when load distribution is needed, the load processing determiner 120 drives the processors 130 and distributes the input data to the processors 130 to distribute the load. On the contrary, when load concentration is needed, the load processing determiner 120 drives part of the processors 130 and outputs the input data to the driven processors 130 to thereby control the load to be concentrated to the part of the processors 130. Here, the number of driven processors 130 in the case of load concentration depends on the traffic processing performance calculated by the traffic processing performance calculator 110.

The processors 130 are operable by control of the load processing determiner 120, and process and output the input data.

The standby buffer 140 compares the output time of the data that are processed through the processors 130 and the current time that is calculated through the timer 150, and temporarily stores the data that are processed through the processors 130 until the time reaches the output time of the processed data. That is, when the current time is before the output time, the standby buffer 140 temporarily stores the processed data, and when the current time reached the output time, it outputs the processed data. Here, the standby buffer 140 can be realized with a calendar queue.

The timer 150 is realized with a counter, and calculates the present time by using the counter. Here, the present time indicates a virtual time calculated by the timer 150.

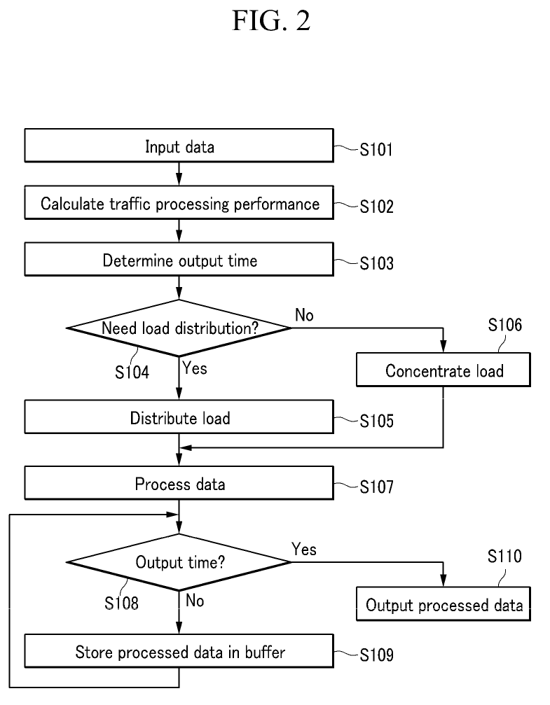

FIG. 2 shows a flowchart of a parallel processing method by a parallel processing system according to an exemplary embodiment of the present invention.

Referring to FIG. 2, the traffic processing performance calculator 110 of the parallel processing system, when receiving data (S101), checks attribute information including the size of the data that are input by analyzing the header of the input data, calculates traffic processing performance including traffic processing capacity and traffic processing time based on attribute information of the input data (S102), and determines the output time for processing and outputting the input data based on the calculated traffic processing time (S103).

The load processing determiner 120 of the parallel processing system determines whether to distribute the load so as to process the input data based on the traffic processing performance calculated by the traffic processing performance calculator 110 (S104), and drives the processors 130 so as to distribute the load when load distribution is needed (S105). On the contrary, when load concentration is needed, the load processing determiner 120 drives part of the processors 130 to concentrate the load on the part of the processors 130 (S106).

The respective processors 130 of the parallel processing system are driven by control of the load processing determiner 120, process and output the input data (S107), and store the data output by the processors 130 in the standby buffer 140.

The standby buffer 140 of the parallel processing system compares the output time calculated by the traffic processing performance calculator 110 and the present time calculated by the timer 150 (S108), stores the data that are processed by the respective processors 130 until the present time reaches the output time (S109), and outputs the processed data when the present time becomes the output time (S110).

In the exemplary embodiment of the present invention, the parallel processing system can determine whether to distribute or concentrate the load by calculating capacity and time for processing traffic on the input data, and controls undesired processor driving and reduces power consumption load by driving all processors when load distribution is needed.

Further, by temporarily storing the processed data and outputting the same at a predetermined output time, the change of a data processing order caused by changing the data processing path is prevented in the load distribution or concentration process.

According to an embodiment of the present invention, when it is determined to distribute the load based on desired capacity and time for processing traffic for input data, all processors are driven to thereby suppress unneeded driving of the processors and reduce power consumption.

Further, by temporally storing the processed data and outputting the same at a predetermined output time, changing the data processing path and accordingly changing the data processing order during the load distribution or concentration process is prevented.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A parallel processing system comprising:
a plurality of processors for processing data;
a traffic processing performance calculator for calculating traffic processing performance based on attribute information of input data, and determining an output time corresponding the data based on the traffic processing performance;
a load processing determiner for driving at least one of the processors according to a load distribution state that is determined based on the traffic processing performance, and controlling the at least one processor to process the data; and
a standby buffer for storing processed data output by the at least one processor, and outputting the processed data based on the output time.

2. The parallel processing system of claim 1, further including
a timer for calculating a present time, wherein
the standby buffer stores the processed data until the present time reaches the output time.

3. The parallel processing system of claim 1, wherein
the traffic processing performance calculator calculates traffic processing capacity included in the traffic processing performance based on the attribute information.

4. The parallel processing system of claim 3, wherein
the traffic processing performance calculator calculates traffic processing time included in the traffic processing performance based on the traffic processing capacity and each processing performance of the plurality of processors.

5. The parallel processing system of claim 4, wherein
the traffic processing performance calculator calculates the output time by adding the traffic processing time to an output time of previously input data.

6. The parallel processing system of claim 1, wherein
the load processing determiner compares the traffic processing performance with a threshold value to determine the load distribution state.

7. The parallel processing system of claim 1, wherein
the load processing determiner drives the plurality of processors so as to process the data when load distribution is determined based on the traffic processing performance.

8. The parallel processing system of claim 1, wherein
the load processing determiner drives part of the plurality of processors so as to process the data when load concentration is determined the traffic processing performance.

9. A parallel processing method in a parallel processing system including a plurality of processors, comprising:
calculating traffic processing capacity and traffic processing time based on attribute information of input data;
determining an output time corresponding to the data based on the traffic processing time;
determining whether to distribute a load based on the traffic processing capacity or the traffic processing time;
driving at least one of the plurality of processors based on the load distribution state;
storing processed data output by processing the data by the at least one processor; and
outputting the processing data based on the output time.

10. The parallel processing method of claim 9, wherein
the calculating includes:
calculating the traffic processing capacity based on the attribute information including size of the data; and
calculating the traffic processing time based on the traffic processing capacity and each processing performance of the plurality of processors.

11. The parallel processing method of claim 9, wherein
the determining of an output time includes
determining the output time by adding the traffic processing time to an output time corresponding to previously input data.

12. The parallel processing method of claim 9, wherein
the determining of whether to distribute a load includes
determining load distribution or load concentration by comparing the traffic processing capacity or the traffic processing time with a threshold value.

13. The parallel processing method of claim 12, wherein
the driving includes
driving the plurality of processors when load distribution is determined.

14. The parallel processing method of claim 12, wherein
the driving includes
driving part of the plurality of processors when load concentration is determined.
